(19) United States
(12) Patent Application Publication
(10) Pub. No.: US 2026/0252495 A1
(43) Pub. Date: Aug. 27, 2026

(54) TECHNIQUES FOR PERFORMING HARDWARE ADDRESS SANITIZATION FOR MEMORY USING ADDRESS TAGGING

(71) Applicant: QUALCOMM Incorporated, San Diego, CA (US)

(72) Inventors: Unni PRASAD, San Diego, CA (US); Gurvinder Singh Chhabra, San Diego, CA (US); Norris Geng, San Diego, CA (US); Kan Wang, San Diego, CA (US); Christopher Koob, Round Rock, TX (US)

(21) Appl. No.: 19/062,380

(22) Filed: Feb. 25, 2025

(51) Int. Cl. G06F 12/1036

(52) U.S. Cl. CPC G06F 12/1036; G06F 2212/68

(57) ABSTRACT

Aspects described herein relate to executing address sanitization of instructions for accessing memory. A translation lookaside buffer (TLB) entry indicating a virtual memory page and an address sanitization mode for the virtual memory page can be obtained for a virtual memory address specified in an instruction for accessing memory. It can be determined, based on the address sanitization mode, whether to enable address sanitization for the instruction for accessing memory. A physical memory address corresponding to the virtual memory address indicated in the TLB entry can be accessed based on the instruction for accessing memory.

### FIELD OF THE DISCLOSURE

Aspects of the present disclosure relate generally to accessing memory in computing devices, and more particularly, to performing hardware address sanitization of memory access instructions.

### DESCRIPTION OF RELATED ART

Address sanitization (ASAN) technologies have been developed to facilitate sanity checking of memory access instructions by software applications executing on computing devices to ensure access of valid or intended memory locations are being requested. ASAN can help protect modern code executing in production from recurring software bugs, which may include temporal memory issues (e.g., heap use after free, stack use after return, stack use after scope), spatial memory issues (e.g., heap buffer overflow, stack buffer overflow, global buffer overflow), use of uninitialized memory, etc. ASAN can tag memory locations to detect whether accesses to the memory locations are valid based on the tag.

ASAN can include software ASAN where additional software code in the software application is used to check memory tags. This can cause memory overhead and performance decrease in the software application, and also may not be enabled in production versions of the software application. ASAN can include hardware ASAN (HWASAN), which is only supported for 64-bit applications, but not 32-bit applications due to the impact of address loss on 32-bit memory access. For example, each bit of memory used for HWASAN can decrease addressable space by half, and thus still causes memory overhead. In addition, HWASAN instructions can act as an accelerator to reduce performance loss, but performance loss may still be significant, and thus HWASAN may not be used in production versions of the software application.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for executing address sanitization of instructions for accessing memory is provided that includes one or more processors, one or more memories coupled with the one or more processors, and instructions stored in the one or more memories. The instructions, when executed by the one or more processors, are operable to cause the apparatus to obtain, for a virtual memory address specified in an instruction for accessing memory, a translation lookaside buffer (TLB) entry indicating a virtual memory page and an address sanitization mode for the virtual memory page, determine, based on the address sanitization mode, whether to enable address sanitization for the instruction for accessing memory, and access, based on the instruction for accessing memory, a physical memory address corresponding to the virtual memory address indicated in the TLB entry.

In another aspect, a computer-implemented method for executing address sanitization of instructions for accessing memory is provided that includes obtaining, for a virtual memory address specified in an instruction for accessing memory, a TLB entry indicating a virtual memory page and an address sanitization mode for the virtual memory page, determining, based on the address sanitization mode, whether to enable address sanitization for the instruction for accessing memory, and accessing, based on the instruction for accessing memory, a physical memory address corresponding to the virtual memory address indicated in the TLB entry.

In another aspect, a computer-readable medium including code executable by one or more processors for executing address sanitization of instructions for accessing memory is provided. The code includes code for obtaining, for a virtual memory address specified in an instruction for accessing memory, a TLB entry indicating a virtual memory page and an address sanitization mode for the virtual memory page, determining, based on the address sanitization mode, whether to enable address sanitization for the instruction for accessing memory, and accessing, based on the instruction for accessing memory, a physical memory address corresponding to the virtual memory address indicated in the TLB entry.

In a further aspect, an apparatus is provided that includes a transceiver, a memory configured to store instructions, and one or more processors communicatively coupled with the transceiver and the memory. The one or more processors are configured to execute the instructions to perform the operations of methods described herein. In another aspect, an apparatus is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a system level block diagram of an example of a device for performing functions related to hardware address sanitization (HWASAN) using selective translation lookaside buffer (TLB) address tagging, in accordance with aspects described herein;

FIG. 2 is a schematic diagram of an example of a TLB entry format, in accordance with aspects described herein;

FIG. 3 is a schematic diagram of an example of memory tagging using a shadow memory for performing HWASAN, in accordance with aspects described herein;

FIG. 4 illustrates a table of a sequence of events or processor clock cycles of a system performing a valid HWASAN check using selective address tagging, in accordance with aspects described herein;

FIG. 5 illustrates a table of a sequence of events or processor clock cycles of a system performing an invalid HWASAN check using selective address tagging, in accordance with aspects described herein;

FIG. 6 illustrates a table of a sequence of events or processor clock cycles of a system that does not perform an HWASAN check based on selective address tagging, in accordance with aspects described herein; and

FIG. 7 illustrates a flow chart of an example of a method 700 for performing HWASAN using selective address tagging, in accordance with aspects described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to providing hardware address sanitization (HWASAN) for memory access instructions using selective translation lookaside buffer (TLB) address tagging. A tag can be specified per virtual memory page to indicate whether HWASAN is enabled for memory addresses in the virtual memory page and/or a HWASAN mode that is enabled for the memory addresses in the virtual memory page. A TLB format for storing TLB entries for virtual memory pages can include, or can be modified to include, one or more bits for indicating whether HWASAN is enabled for virtual memory addresses in the virtual memory page and/or a HWASAN mode to be used. For example, the HWASAN mode can indicate a tag granule and/or tag size used to tag the memory addresses with relevant information for ASAN, such as shadow memory information for validating memory access instructions. In this regard, in an example, given a memory access instruction for a virtual memory address, the TLB entry corresponding to the virtual memory page associated with the virtual memory address can be obtained and analyzed to determine whether HWASAN is enabled for the virtual memory access and/or the HWASAN mode. A HWASAN engine can be triggered for analyzing a memory access instruction when, according to the TLB entry for the virtual memory page associated with the requested virtual memory address, HWASAN is enabled and/or based on the parameters of the HWASAN mode.

In some examples described herein, an asynchronous ASAN mode can be supported as well, where memory addresses to be validated can be queued for validation without impacting execution of the software application. As a separate process, HWASAN engine can evaluate the memory addresses and can perform HWASAN for one or more of the memory addresses based on the TLB entry for each memory page associated with each memory address, as described above. In an example, the queue can be of fixed size, and queued memory addresses can be evicted based on a random selection when the queue is full to improve likelihood of covering distinct memory accesses with randomly dropped candidates. In addition, in some examples multiple HWASAN tests can be executed as the software application executes, which can allow for reducing tag size overhead as additional executions can improve probability of error detection by the HWASAN process.

Using selective TLB address tagging can allow for activating HWASAN tagging at the virtual memory page level, which can reduce the number of bits used for tagging when compared to address level tagging. Thus, the selective TLB address tagging described herein can improve memory overhead compared to conventional HWASAN technologies, which may allow for executing the HWASAN based on selective TLB address tagging on software applications in production. In addition, the reduction in memory overhead and may allow for HWASAN based on selective TLB address tagging to be used with 32-bit systems, as the associated memory overhead that prevented use of HWASAN for 32-bit addressing (e.g., significant reduction in addressable space) can be significantly reduced. Moreover, the asynchronous mode for HWASAN based on selective TLB address tagging can provide a non-blocking mode that may allow for achieving minimal performance overhead, which may further enable operation for software applications in production.

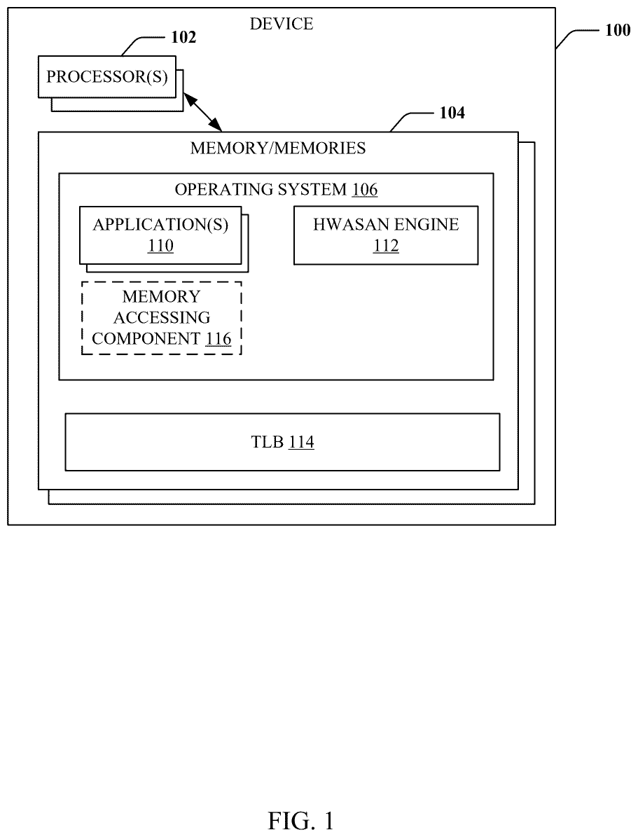

The described features will be presented in more detail below with reference to FIGS. 1-7.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a system level block diagram of an example of a device 100 (e.g., a computing device) for performing functions related to HWASAN using selective TLB address tagging, in accordance with aspects described herein. In an example, device 100 can include one or more processors 102 and/or memory/memories 104 configured to execute or store instructions or other parameters related to providing an operating system 106, which can execute one or more applications or processes. For example, processor(s) 102 and memory/memories 104 may be separate components communicatively coupled by a bus (e.g., on a motherboard or other portion of a computing device, on an integrated circuit, such as a system on a chip (SoC), etc.), components integrated within one another (e.g., processor(s) 102 can include the memory/memories 104 as an on-board component), and/or the like. Memory/memories 104 may store instructions, parameters, data structures, etc. for use/execution by processor(s) 102 to perform functions described herein. In another example, processor(s) 102 and/or memory/memories 104 can be distributed over multiple devices or physical computing nodes in a network (e.g., in a cloud-based computing platform) for providing the functions of the various components described herein.

In one example, the operating system 106 can execute one or more applications 110 or processes, which may include software applications executing in a production mode or other mode. The operating system 106 can also execute a HWASAN engine 112 for performing HWASAN for a memory address in a memory instruction based on whether HWASAN is enabled (and/or a HWASAN mode) for a virtual memory page corresponding to the memory address. The operating system 106 can also execute a memory accessing component 116 for accessing memory locations in memory/memories 104, by executing one or more memory accessing instructions, based on instructions from the one or more applications 110. For example, the memory accessing instructions can include instructions to fetch data from memory address locations in memory/memories 104 (e.g., a memw instruction), load or store the data to one or more registers (not shown), etc. The memory accessing component 116 may trigger the HWASAN engine 112 to execute for one or more memory locations based on information obtained when processing the memory accessing instructions. Memory/memories 104 can also include a TLB 114 that is used by the operating system 106 (e.g., by memory accessing component 116) to translate virtual memory addresses received in the memory accessing instructions to physical memory addresses in memory/memories 104.

The TLB 114 can include various table entries, where each entry can specify a virtual memory page and a corresponding physical memory address, such that memory accessing component 116 can translate a given virtual memory address to a physical memory address. For example, memory accessing component 116 can determine the virtual memory page associated with the virtual memory address, the starting address in physical memory of the virtual memory page obtained from the TLB entry for the virtual memory page in TLB 114, and an offset from the starting address of the virtual memory page. In an example, the format of the TLB entries in the TLB 114 can include, or can be extended to include, HWASAN mode information. The HWASAN mode information can indicate whether HWASAN is enabled and/or a mode for HWASAN for a given virtual memory page (e.g., for all virtual memory addresses in the virtual memory page). For example, the HWASAN mode information can include a single bit indicating that HWASAN is enabled or disabled for the virtual memory page, or can include multiple bits indicating various information for HWASAN mode, such as a tag granule (TG), tag size (TS), etc., as described herein.

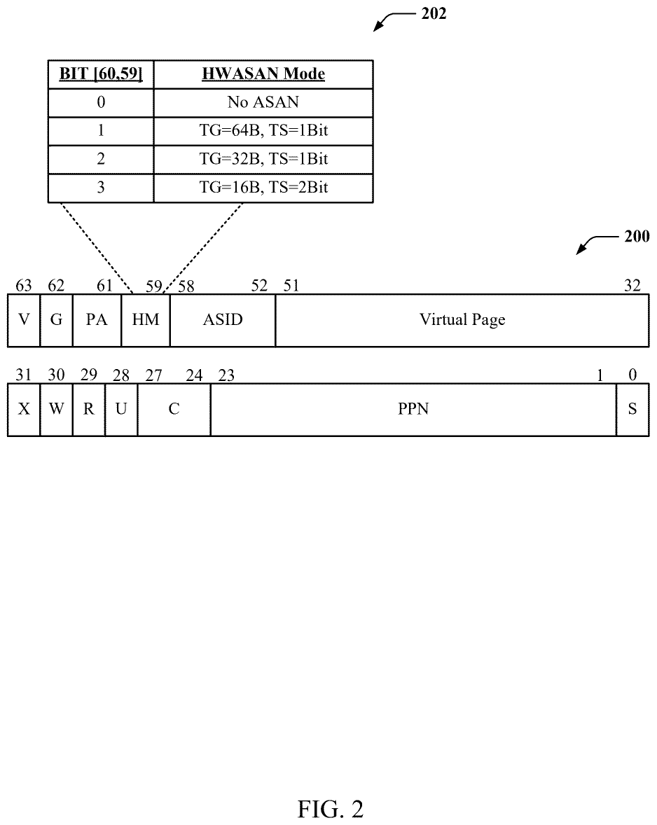

FIG. 2 is a schematic diagram of an example of a TLB entry format 200, in accordance with aspects described herein. For example, TLB 114 can include a table or other structure of TLB entries, where each TLB entry can be for a different virtual memory page and can be of TLB entry format 200. For example, TLB entry format 200 can include 64 bits used to indicate various information about a virtual memory page, such as PPN (Bits [23:1]), which can include bits 34:12 of a physical address of the memory location, S (Bit [0]), which can be a size bit to assist in determining a page size, C (Bits [27:24], which can include cacheability attributes of the page defined by the processor architecture (e.g., where each unique number can map to a predefined level 1 instruction (L1I), level 1 data (L1D), and/or level 2 (L2) cacheability setting, U (Bit [28]), which can indicate a user mode (e.g., if set (1), user mode can be allowed to access this page per the R, W, X bits; if cleared (0) a user mode access can result in a permissions violation), R (Bit [29]), which can represent read enable (e.g., if set, user mode and guest mode programs can read this page), W (Bit [30]), which can represent write enable (e.g., if set, user mode and guest mode programs can write this page), X (Bit) [31], which can represent execute enable (e.g., if set, user mode and guest mode programs can execute from this page), Virtual Page (Bits 51:32), which can indicate a virtual page number that is matched against the memory access address, ASID (Bits [58:52], which can include a 7-bit address space identifier, HM (Bits [60:59]), which can indicate the HWASAN mode, as described herein, PA (Bit [61]), which can include bit 35 of a physical address, G (Bit [62]), which can include a global bit (e.g., the MMU can ignore the ASID when the global bit is set), and/or V (Bit [63]), which can represent a valid bit (e.g., the MMU can use the valid bit to indicate whether this entry is used for matching, or can reset to clear this bit for all TLB entries).

In one example, bits 60 and 59 can be used to define HWASAN mode, as shown in table 202. For example, a value of 0 (‘00’) can indicate no ASAN for the virtual memory page, a value of 1 (‘01’) can indicate ASAN with TG=64 bytes and TS=1 bit for the virtual memory page, a value of 2 (‘10’) can indicate ASAN with TG=32 bytes and TS=1 bit for the virtual memory page, and a value of 3 (‘11’) can indicate ASAN with TG=16 bytes and TS=2 bit for the virtual memory page. As described, for example, for a virtual memory address specified in a memory access request, memory accessing component 116 can determine the virtual memory page associated with the virtual memory address, obtain the TLB entry for the virtual memory page, and determine whether HWASAN is enabled and/or associated TG and/or TS parameters based on one or more bits in the TLB entry. In an example, memory accessing component 116 can trigger the HWASAN engine 112 to execute HWASAN, or accordingly query the HWASAN engine 112, for the virtual memory address where memory accessing component 116 detects HWASAN enabled for the virtual memory page. In an example, for virtual memory pages having HWASAN enabled, a memory tagging technique, e.g., by a memory coloring or memory painting, can be used to create a shadow memory to tag memory locations. The HWASAN engine 112 can use the shadow memory to authorize data memory access by verifying the memory tags or colors, while the contents of the memory can be ignored by the HWASAN engine 112.

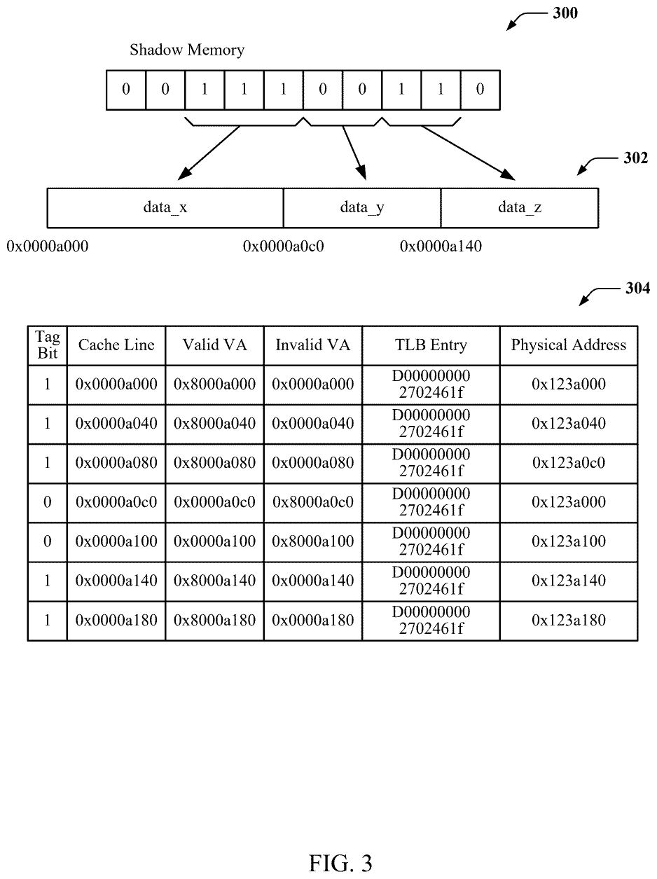

FIG. 3 is a schematic diagram of an example of memory tagging using a shadow memory 300 for performing HWASAN, in accordance with aspects described herein. For example, shadow memory 300 can define a two color tagging for memory locations 302. In an example, the shadow memory 300 can represent the memory coloring of memory locations 302 at a configurable tag granule (TG) and/or tag size (TS). The TG and TS can correspond to a HWASAN mode that may be configured per virtual memory page, as described herein. In one example, the TG can be 64 bytes and the TS can be 1 bit, in which case a 1 bit tag is specified for each 64 bytes of memory addresses, where a 1 bit tag allows for two possible memory colors. Additional configurations are possible to allow for more memory colors and/or more or less bytes indicated per tag (e.g., TG=32 bytes and TS=1 bit, or TG=16 bytes and TS=2 bits, etc.).

In the example in FIG. 3, TG=64 bytes and TS=1 bit for TLB entry (e.g., virtual memory page) D00000000 2702461f (e.g., based on the bits in positions 60, 59 of the TLB entry indicating the value of a (‘01’). For example, in the TLB 114, this virtual memory page can include a TLB entry with one or more bits to indicate enabling HWASAN mode and/or configuration parameters for HWASAN (e.g., TG, TS, etc.). Thus, as shown in the table 304, which can visually represent TLB mapping information for virtual memory addresses, shadow memory 300 can include a memory tag or color (e.g., 0 or 1 bit) for each 64 bytes of memory (e.g., a tag for virtual memory address 0x0000a000, a tag for virtual memory address 0x0000a0040, etc.). Each virtual memory location corresponding to a complete memory allocation (e.g., data_x, data_y, or data_z) can have a different memory tag/color than adjacent virtual memory locations. Table 304 shows, for each cache line in the virtual memory page, a valid virtual address (VA) that can be used to access memory locations in the cache line and an invalid VA that can be sued to access the memory locations. In the example shown in FIG. 3, a valid VA for a virtual memory address includes the tag bit in the most significant bit (MSB) of the virtual memory address (e.g., where tag bit=1, the valid VA has a 1 in the MSB of the virtual memory address). In this regard, for example, the HWASAN engine 112 can verify or authorize memory access instructions based on whether the specified virtual memory address has MSB (or one or more MSBs) that corresponds to the tag bit (or tag bits) in the shadow memory 300 for the virtual memory addresses of memory locations 302 (e.g., as specified in the table 304).

The table 304 also indicates the physical address to which the given cache line maps in physical memory. In an example, operating system 106 or one or more applications executing via the operating system 106 can create and/or store a shadow memory table that specifies the shadow memory information for a set of virtual memory addresses (e.g., a set of virtual memory pages). The shadow memory table may include one or more columns of the table 304 to allow the HWASAN engine 112 to determine the shadow memory information to verify or authorize memory accesses, to allow the memory accessing component 116 to determine whether to activate HWASAN for a virtual memory page, to allow the memory accessing component 116 to determine a physical memory address corresponding to a virtual memory address referenced in memory access instructions, and/or the like.

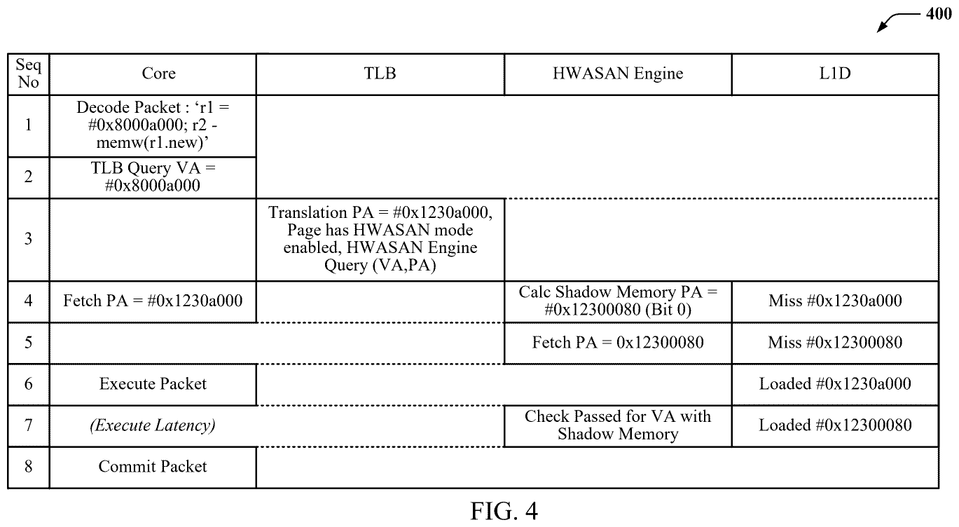

FIG. 4 illustrates a table 400 of a sequence of events or processor clock cycles of a system performing a valid HWASAN check using selective address tagging, in accordance with aspects described herein. Table 400 illustrates events among, or communication between, a processor core, the TLB 114, the HWASAN engine 112, and level 1 data (L1D) cache. At sequence number 1, the core decodes a packet indicating r1=#0x8000a000; r2=memw(r1.new), which can cause fetching for virtual memory address #0x8000a000. Based on receiving this instruction, at sequence number 2, memory accessing component 116 (e.g., via the core) can query the TLB 114 based on VA=#0x8000a000 to determine the TLB entry for the virtual memory page corresponding to the address (e.g., D00000000 2702461f in the above example). The TLB entry can indicate whether HWASAN is enabled and/or one or more parameters for HWASAN for the virtual memory page (e.g., TG=64 bytes; TS=1 bit). The TLB entry can also indicate the virtual memory page or corresponding virtual memory addresses, along with a physical page number associated with the virtual memory page. Accordingly, based on the TLB entry, at sequence number 3, memory accessing component 116 can determine that HWASAN is enabled with parameters TG=64 bytes; TS=1 bit, and can also determine that VA #0x8000a000 translates to physical address (PA) #0x1230a000 in physical memory (e.g., memory/memories 104). Memory accessing component 116 can accordingly query the HWASAN engine 112, specifying the VA and PA, to verify/authorize the memory access instruction.

At sequence number 4, memory accessing component 116 (e.g., via the core) can execute a fetch PA=#0x1230a000 to cause L1D to access the memory at the PA, and this fetch may result in a cache miss at the L1D, as the L1D may not yet have loaded the memory contents from PA. In addition, at sequence number 4, the HWASAN engine 112, which may execute as a separate process from memory accessing component 116, can calculate the shadow memory to start at bit 0 of PA #0x12300080 (which may be the page start) to access the shadow memory corresponding to the VA. At sequence number 5, the HWASAN engine 112 can execute a fetch PA=#0x12300080 to access the shadow memory PA, which may result in a cache miss at the L1D. At sequence number 6, L1D can load, or confirm loading of, the contents of PA #0x1230a000, and the memory accessing component 116 can execute the packet to load the memory contents of the PA #0x1230a000. At sequence number 7, L1D can load, or confirm loading of, the contents of the shadow memory PA #0x12300080, and the HWASAN engine 112 can accordingly determine that the check passed for the VA with the shadow memory (e.g., the shadow memory bit value matched the value of the MSB of the VA). At sequence number 8, the memory accessing component 116 can commit the packet based on the HWASAN check passing.

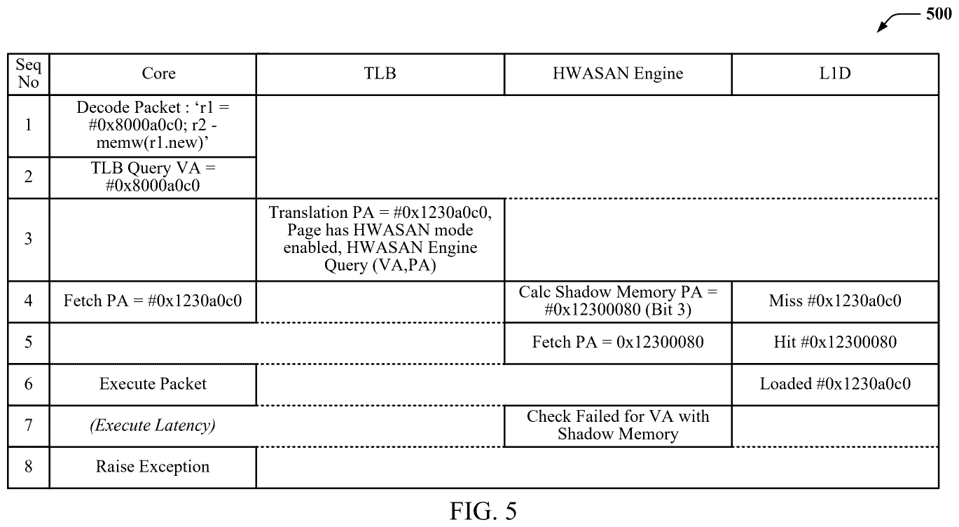

FIG. 5 illustrates a table 500 of a sequence of events or processor clock cycles of a system performing an invalid HWASAN check using selective address tagging, in accordance with aspects described herein. Table 500 illustrates events among, or communication between, a processor core, the TLB 114, the HWASAN engine 112, and L1D cache. At sequence number 1, the core decodes a packet indicating r1=#0x8000a0c0; r2=memw(r1.new), which can cause fetching for virtual memory address #0x8000a0c0. Based on receiving this instruction, at sequence number 2, memory accessing component 116 (e.g., via the core) can query the TLB 114 based on VA=#0x8000a0c0 to determine the TLB entry for the virtual memory page corresponding to the address (e.g., D00000000 2702461f in the above example). Based on the TLB entry, at sequence number 3, memory accessing component 116 can determine that HWASAN is enabled with parameters TG=64 bytes; TS=1 bit, and can also determine that VA #0x8000a0c0 translates to PA #0x1230a0c0 in physical memory (e.g., memory/memories 104). Memory accessing component 116 can accordingly query the HWASAN engine 112, specifying the VA and PA, to verify/authorize the memory access instruction.

At sequence number 4, memory accessing component 116 (e.g., via the core) can execute a fetch PA=#0x1230a0c0 to cause L1D to access the memory at the PA, and this fetch may result in a cache miss at the L1D, as the L1D may not yet have loaded the memory contents from PA. In addition, at sequence number 4, the HWASAN engine 112, which may execute as a separate process from memory accessing component 116, can calculate the shadow memory to start at bit 3 of PA #0x12300080 (e.g., the TG=64 bytes, TS=1 bit, and #0x1230a0c0 is 4 64 byte segments from #0x1230a000, which may be the page start) to access the shadow memory corresponding to the VA. At sequence number 5, the HWASAN engine 112 can execute a fetch PA=#0x12300080 to access the shadow memory PA, which may result in a cache hit at the L1D (e.g., as the same cache line may have been loaded during the sequence of events illustrated in FIG. 4). At sequence number 6, L1D can load, or confirm loading of, the contents of PA #0x1230a000, and the memory accessing component 116 can execute the packet to load the memory contents of the PA #0x1230a000. At sequence number 7, L1D can load, or confirm loading of, the contents of the shadow memory PA #0x12300080, and the HWASAN engine 112 can accordingly determine that the check failed for the VA with the shadow memory (e.g., the shadow memory bit value did not match the value of the MSB of the VA). At sequence number 8, the memory accessing component 116 can raise an exception based on the HWASAN check failing.

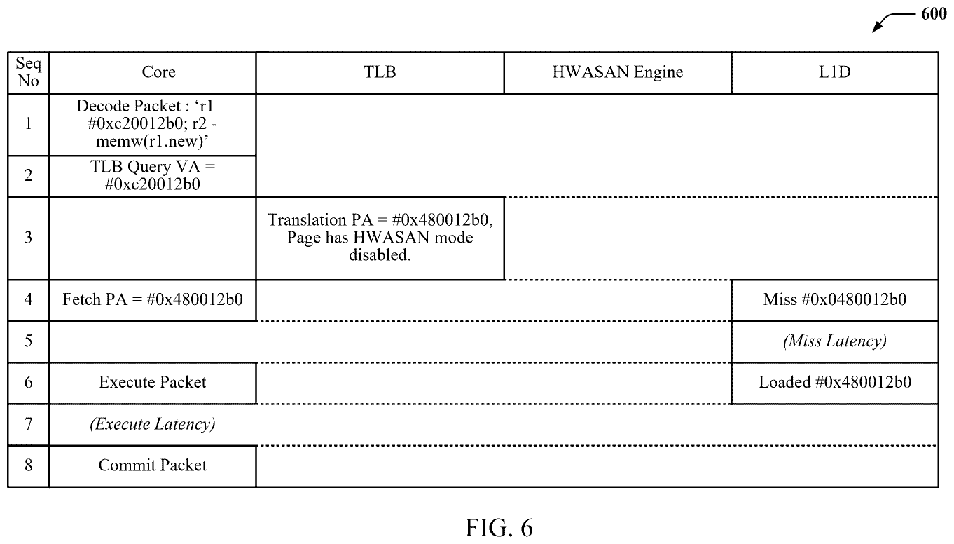

FIG. 6 illustrates a table 600 of a sequence of events or processor clock cycles of a system that does not perform an HWASAN check based on selective address tagging, in accordance with aspects described herein. Table 600 illustrates events among, or communication between, a processor core, the TLB 114, the HWASAN engine 112, and L1D cache. At sequence number 1, the core decodes a packet indicating r1=#0xc20012b0; r2=memw(r1.new), which can cause fetching for virtual memory address #0xc20012b0. Based on receiving this instruction, at sequence number 2, memory accessing component 116 (e.g., via the core) can query the TLB 114 based on VA=#0xc20012b0 to determine the TLB entry for the virtual memory page corresponding to the address. Based on the TLB entry, at sequence number 3, memory accessing component 116 can determine that HWASAN is disabled, and can also determine that VA #0xc20012b0 translates to PA #0x480012b0 in physical memory (e.g., memory/memories 104). As HWASAN is disabled, memory accessing component 116 can proceed with fetching the PA without performing HWASAN or triggering the HWASAN engine 112.

At sequence number 4, memory accessing component 116 (e.g., via the core) can execute a fetch PA=#0x480012b0 to cause L1D to access the memory at the PA, and this fetch may result in a cache miss at the L1D, as the L1D may not yet have loaded the memory contents from PA. At sequence number 6, L1D can load, or confirm loading of, the contents of PA #0x480012b0, and the memory accessing component 116 can execute the packet to load the memory contents of the PA #0x480012b0. At sequence number 8, the memory accessing component 116 can commit the packet.

Though shown and described in FIGS. 4-6 as executing as part of the core accessing memory, in some examples, HWASAN engine 112 can execute asynchronously from the core to reduce delay otherwise introduced into the memory accessing pipeline. In this example, memory accessing component 116 can queue VAs from memory accessing instructions in a buffer, and can independently and asynchronously perform HWASAN on the memory addresses. In an example, memory accessing component 116 can accordingly proceed with committing packets, and HWASAN engine 112 can raise exceptions in the independent process, which can include logging exceptions for later review. In an example, when the buffer of VAs is full, random candidates can be evicted from the buffer to make room for new addresses when memory accessing component 116 encounters additional VAs for which HWASAN is enabled. In an example, HWASAN engine 112 performing repeated HWASAN tests with randomly dropped candidates can improve test case coverage for the application(s) 110. Moreover, increasing test case coverage with multiple tests can achieve a similar coverage as using a larger tag size, which can thus allow for decreasing the tag size (e.g., to 1 bit) with a similar test case coverage and HWASAN effectiveness. Using a smaller tag size (e.g., 1 bit) can improve the addressable space in memory/memories 104 impacted by enabling HWASAN.

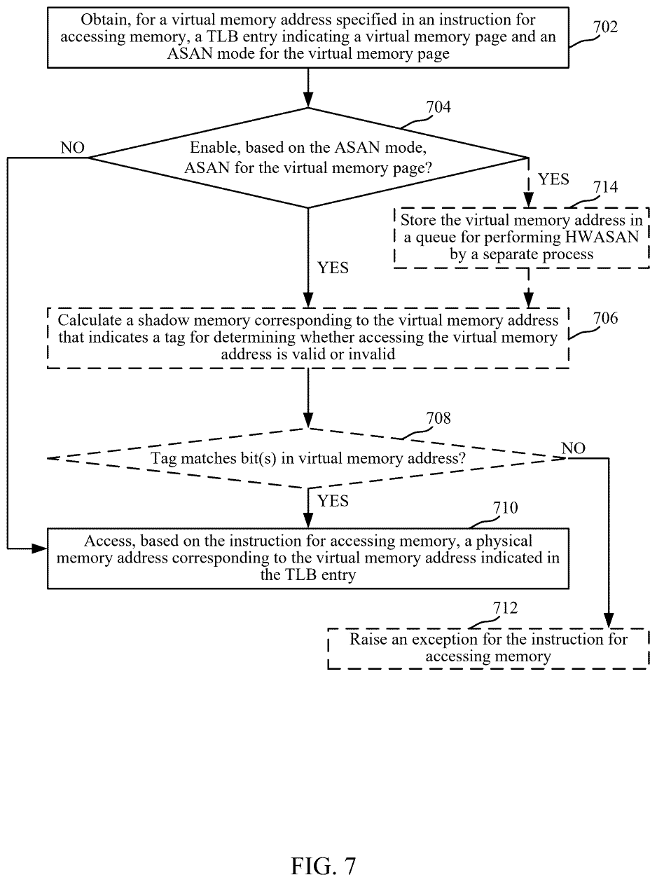

FIG. 7 illustrates a flow chart of an example of a method 700 for performing HWASAN using selective address tagging, in accordance with aspects described herein. In an example, a device 100 can perform the functions described in method 700 shown in FIG. 7 using one or more of the components described in FIG. 1.

In method 700, at Block 702, a TLB entry indicating a virtual memory page and an ASAN mode for the virtual memory page can be obtained for a virtual memory address specified in an instruction for accessing memory. In an aspect, memory accessing component 116, e.g., in conjunction with processor(s) 102, memory/memories 104, operating system 106, etc., can obtain, for a virtual memory address specified in the instruction for accessing memory, the TLB entry indicating the virtual memory page and the ASAN mode for the virtual memory page. For example, one or more applications 110 can execute instructions to access the memory/memories 104, which memory accessing component 116 can receive and execute corresponding lower level memory accessing instructions, such as memw. Based on the virtual memory address specified in, or for, the memory accessing instruction, memory accessing component 116 can obtain the TLB entry from TLB 114 that corresponds to the virtual memory address. For example, memory accessing component 116 can determine the virtual memory page based on a page size and a starting address of the virtual memory page, and can query the TLB 114 for the TLB entry associated with the virtual memory page.

As described, the TLB entry may indicate the starting virtual memory address for the virtual memory page, the physical page number in physical memory associated with the virtual memory page, along with additional information, which may include a HWASAN mode for the virtual memory page. For example, the HWASAN mode can include a single bit indicating whether HWASAN is enabled for the virtual memory page, multiple bits indicating whether HWASAN is enabled, and if so, one or more parameters, such as TG and/or TS, etc. In method 700, at Block 704, it can be determined whether to enable, based on the ASAN mode, ASAN for the virtual memory page. In an aspect, memory accessing component 116, e.g., in conjunction with processor(s) 102, memory/memories 104, operating system 106, etc., can determine whether to enable, based on the ASAN mode, ASAN for the virtual memory page. For example, where the TLB entry for the virtual memory page indicates to enable HWASAN (and/or parameters for HWASAN), memory accessing component 116 can trigger the HWASAN engine 112 to execute for the instruction for accessing memory (e.g., for the corresponding virtual memory address).

Based on determining to enable ASAN mode for the virtual memory page at Block 704, in method 700, optionally at Block 706, a shadow memory corresponding to the virtual memory address that indicates a tag for determining whether accessing the virtual memory address is valid or invalid can be calculated. In an aspect, HWASAN engine 112, e.g., in conjunction with processor(s) 102, memory/memories 104, operating system 106, etc., can calculate the shadow memory corresponding to the virtual memory address that indicates the tag for determining whether accessing the virtual memory address is valid or invalid. For example, given the HWASAN parameters, e.g., TG and TS, HWASAN engine 112 can compute the shadow memory for at least a portion of the virtual memory page based on size of data stored at each memory location. For example, starting at the beginning of the virtual page, HWASAN engine 112 can assign a first tag to a first memory location and/or one or more adjacent memory locations based on the TG and the size of first data stored in the first memory location, assign a second tag to a second memory location and/or one or more second adjacent memory locations after the memory locations associated with the first data, and so on, cycling through the tags based on TS.

In method 700, optionally at Block 708, it can be determined whether the tag matches bit(s) in the virtual memory address. In an aspect, HWASAN engine 112, e.g., in conjunction with processor(s) 102, memory/memories 104, operating system 106, etc., can determine whether the tag associated with the virtual memory address in the shadow memory matches the bit(s) in the virtual memory address. For example, the bit(s) in the virtual memory address can be the MSB(s) or substantially any bit(s) in the virtual memory address. In one example, a 1 bit tag can be used, as described above, where HWASAN engine 112 can check the 1 bit tag against the MSB or other bit of the virtual memory address. In another example, a n bit tag can be used (n>1), and HWASAN engine 112 can check the n bit tag against a collection of n bits of the virtual memory address. If the tag bit(s) matches/match the bit(s) in the virtual memory address, the sanitization check passes (e.g., is successful).

In this case, in method 700, at Block 710, a physical memory address corresponding to the virtual memory address indicated in the TLB entry can be access based on the instruction for accessing memory. In an aspect, memory accessing component 116, e.g., in conjunction with processor(s) 102, memory/memories 104, operating system 106, etc., can access, based on the instruction for accessing memory, the physical address corresponding to the virtual memory address indicated in the TLB entry. As described, for example, memory accessing component 116 can determine the physical memory address based on the TLB entry for the virtual memory page in TLB 114. For example, memory accessing component 116 can determine the physical memory address based on the PPN in the TLB entry and/or an offset from the start of the physical memory page corresponding to the PPN. Memory accessing component 116 can accordingly access the memory, which may include fetching data from the physical memory location, storing data to the physical memory location, and/or the like. In this example, memory accessing component 116 can access the physical memory location based on the tag matching the bit in the virtual memory address at Block 708.

Where the tag does not match the bit in the virtual memory address at Block 708, optionally at Block 712, an exception can be raised for the instruction for accessing memory. In an aspect, memory accessing component 116, e.g., in conjunction with processor(s) 102, memory/memories 104, operating system 106, etc., can raise the exception for the instruction for accessing memory. In one example, raising the exception can include logging one or more parameters related to the memory accessing instruction, failure thereof, shadow memory value expected, etc. In one example, raising the exception can include interrupting the application(s) 110 requesting the memory access. Memory accessing component 116 may or may not subsequently allow accessing of the physical memory location after raising the exception.

In another example, where it is determined that ASAN is not enabled for the virtual memory page at Block 704, method 700 can proceed to Block 710 for accessing, based on the instruction for accessing memory, the physical memory address corresponding to the virtual memory address indicated in the TLB entry without performing ASAN.

In another example, where the HWASAN engine 112 operates in an asynchronous mode, before (or after) calculating the shadow memory at Block 706, optionally at Block 714, the virtual memory address can be stored in a queue for performing HWASAN by a separate process. In an aspect, memory accessing component 116, e.g., in conjunction with processor(s) 102, memory/memories 104, operating system 106, etc., can store the virtual memory address in the queue for performing HWASAN by the separate process. In an example, HWASAN engine 112 can operate as a separate process asynchronously to the memory accessing component 116 and/or application(s) 110 to perform HWASAN for the instructions to access memory after the instructions are executed by memory accessing component 116. In this example, HWASAN engine 112 can operate as a separate process without blocking application 110 and can raise or log exceptions when shadow memory tag does not match the bit in the corresponding virtual memory address. As described, in asynchronous mode, HWASAN engine 112 can process HWASAN on the virtual memory addresses in the queue, removing the virtual memory addresses from the queue as they are processed. If the queue is full, memory accessing component 116 can evict a virtual memory address from the queue at random to replace with a virtual memory address specified in a currently executed instruction. The HWASAN engine 112 can repeatedly execute on random virtual memory addresses in this regard, which can improve error detection, as described. In asynchronous mode, for example, HWASAN engine 112 can perform Blocks 706, 708, and 712 without blocking the application(s). If the tag matches the bit(s) at Block 708, HWASAN engine 112 operating in asynchronous mode can proceed to the next virtual memory address in the queue (and/or may log information regarding a successful match).

The following aspects are illustrative only and aspects thereof may be combined with aspects of other embodiments or teaching described herein, without limitation.
Aspect 1 is a method for executing address sanitization of instructions for accessing memory including obtaining, for a virtual memory address specified in an instruction for accessing memory, a TLB entry indicating a virtual memory page and an address sanitization mode for the virtual memory page, determining, based on the address sanitization mode, whether to enable address sanitization for the instruction for accessing memory, and accessing, based on the instruction for accessing memory, a physical memory address corresponding to the virtual memory address indicated in the TLB entry.
In Aspect 2, the method of Aspect 1 includes where, where the address sanitization mode indicates to perform address sanitization for the virtual memory page, determining whether to enable address sanitization includes determining to enable address sanitization for the instruction for accessing memory.
In Aspect 3, the method of Aspect 2 includes, based on determining to enable address sanitization for the instruction for accessing memory, calculating a shadow memory corresponding to the virtual memory address that indicates a tag for determining whether accessing the virtual memory address is valid or invalid, and where the tag does not match a specific bit in the virtual memory address, initiating an exception caused by the instruction for accessing memory.
In Aspect 4, the method of Aspect 3 includes where at least one of calculating the shadow memory or initiating the exception where the tag does not match a specific bit in the virtual memory address is performed by a separate process that is independent of accessing the physical memory address.
In Aspect 5, the method of Aspect 4 includes, based on determining to enable address sanitization for the instruction for accessing memory, storing the virtual memory address in a queue for performing address sanitization by the separate process.
In Aspect 6, the method of any of Aspects 3 to 5 includes where the specific bit is a most significant bit of the virtual memory address.
In Aspect 7, the method of any of Aspects 3 to 6 includes where the tag for each virtual memory address is randomly selected from multiple tag values corresponding to a tag size.
In Aspect 8, the method of any of Aspects 3 to 7 includes where the address sanitization mode indicates a tag granularity of memory and a tag size for calculating the shadow memory.
In Aspect 9, the method of any of Aspects 1 to 8 includes where the address sanitization mode corresponds to a parameter having multiple possible values, where at least a first value of the multiple possible values indicates disabling address sanitization and at least a second value of the multiple possible values indicates enabling address sanitization.
In Aspect 10, the method of any of Aspects 1 to 9 includes where the address sanitization mode corresponds to a parameter having multiple possible values, where at least a first value of the multiple possible values indicates enabling address sanitization based at least in part on a first granularity of memory to which a tag is associated in the shadow memory and a first tag size for each portion of memory corresponding to the first granularity, and where at least a second value of the multiple possible values indicates enabling address sanitization based at least in part on a second granularity of memory to which a tag is associated in the shadow memory and a second tag size for each portion of memory corresponding to the second granularity.
Aspect 11 is an apparatus including one or more processors, one or more memories coupled with the one or more processors, and instructions stored in the one or more memories and operable, when executed by the one or more processors, to cause the apparatus to perform any of the methods of Aspects 1 to 10.
Aspect 12 is an apparatus including means for performing any of the methods of Aspects 1 to 10.
Aspect 13 is one or more computer-readable media including code executable by one or more processors, the code including code for performing any of the methods of Aspects 1 to 10.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for executing address sanitization of instructions for accessing memory, comprising:
one or more processors;
one or more memories coupled with the one or more processors; and
instructions stored in the one or more memories and operable, when executed by the one or more processors, to cause the apparatus to:
obtain, for a virtual memory address specified in an instruction for accessing memory, a translation lookaside buffer (TLB) entry indicating a virtual memory page and an address sanitization mode for the virtual memory page;
determine, based on the address sanitization mode, whether to enable address sanitization for the instruction for accessing memory; and
access, based on the instruction for accessing memory, a physical memory address corresponding to the virtual memory address indicated in the TLB entry.

2. The apparatus of claim 1, wherein, where the address sanitization mode indicates to perform address sanitization for the virtual memory page, the instructions, when executed by the one or more processors, cause the apparatus to determine whether to enable address sanitization including determining to enable address sanitization for the instruction for accessing memory.

3. The apparatus of claim 2, wherein the instructions, when executed by the one or more processors, cause the apparatus to, based on determining to enable address sanitization for the instruction for accessing memory:
calculate a shadow memory corresponding to the virtual memory address that indicates a tag for determining whether accessing the virtual memory address is valid or invalid; and
where the tag does not match a specific bit in the virtual memory address, initiate an exception caused by the instruction for accessing memory.

4. The apparatus of claim 3, wherein the instructions, when executed by the one or more processors, cause the apparatus to at least one of calculate the shadow memory or initiate the exception where the tag does not match a specific bit in the virtual memory address by a separate process that is independent of accessing the physical memory address.

5. The apparatus of claim 4, wherein the instructions, when executed by the one or more processors, cause the apparatus to, based on determining to enable address sanitization for the instruction for accessing memory, store the virtual memory address in a queue for performing address sanitization by the separate process.

6. The apparatus of claim 3, wherein the specific bit is a most significant bit of the virtual memory address.

7. The apparatus of claim 3, wherein the tag for each virtual memory address is randomly selected from multiple tag values corresponding to a tag size.

8. The apparatus of claim 3, wherein the address sanitization mode indicates a tag granularity of memory and a tag size for calculating the shadow memory.

9. The apparatus of claim 1, wherein the address sanitization mode corresponds to a parameter having multiple possible values, wherein at least a first value of the multiple possible values indicates disabling address sanitization and at least a second value of the multiple possible values indicates enabling address sanitization.

10. The apparatus of claim 1, wherein the address sanitization mode corresponds to a parameter having multiple possible values,
wherein at least a first value of the multiple possible values indicates enabling address sanitization based at least in part on a first granularity of memory to which a tag is associated in a shadow memory and a first tag size for each portion of memory corresponding to the first granularity, and
wherein at least a second value of the multiple possible values indicates enabling address sanitization based at least in part on a second granularity of memory to which a tag is associated in the shadow memory and a second tag size for each portion of memory corresponding to the second granularity.

11. A computer-implemented method for executing address sanitization of instructions for accessing memory, comprising:
obtaining, for a virtual memory address specified in an instruction for accessing memory, a translation lookaside buffer (TLB) entry indicating a virtual memory page and an address sanitization mode for the virtual memory page;
determining, based on the address sanitization mode, whether to enable address sanitization for the instruction for accessing memory; and
accessing, based on the instruction for accessing memory, a physical memory address corresponding to the virtual memory address indicated in the TLB entry.

12. The computer-implemented method of claim 11, wherein, where the address sanitization mode indicates to perform address sanitization for the virtual memory page, determining whether to enable address sanitization includes determining to enable address sanitization for the instruction for accessing memory.

13. The computer-implemented method of claim 12, further comprising, based on determining to enable address sanitization for the instruction for accessing memory:
calculating a shadow memory corresponding to the virtual memory address that indicates a tag for determining whether accessing the virtual memory address is valid or invalid; and
where the tag does not match a specific bit in the virtual memory address, initiating an exception caused by the instruction for accessing memory.

14. The computer-implemented method of claim 13, wherein at least one of calculating the shadow memory or initiating the exception where the tag does not match a specific bit in the virtual memory address is performed by a separate process that is independent of accessing the physical memory address, and further comprising, based on determining to enable address sanitization for the instruction for accessing memory, storing the virtual memory address in a queue for performing address sanitization by the separate process.

15. The computer-implemented method of claim 13, wherein the specific bit is a most significant bit of the virtual memory address.

16. The computer-implemented method of claim 13, wherein the tag for each virtual memory address is randomly selected from multiple tag values corresponding to a tag size.

17. The computer-implemented method of claim 13, wherein the address sanitization mode indicates a tag granularity of memory and a tag size for calculating the shadow memory.

18. The computer-implemented method of claim 11, wherein the address sanitization mode corresponds to a parameter having multiple possible values, wherein at least a first value of the multiple possible values indicates disabling address sanitization and at least a second value of the multiple possible values indicates enabling address sanitization.

19. A computer-readable medium, comprising code executable by one or more processors for executing address sanitization of instructions for accessing memory, the code comprising code for:
obtaining, for a virtual memory address specified in an instruction for accessing memory, a translation lookaside buffer (TLB) entry indicating a virtual memory page and an address sanitization mode for the virtual memory page;
determining, based on the address sanitization mode, whether to enable address sanitization for the instruction for accessing memory; and
accessing, based on the instruction for accessing memory, a physical memory address corresponding to the virtual memory address indicated in the TLB entry.

20. The computer-readable medium of claim 19, wherein, where the address sanitization mode indicates to perform address sanitization for the virtual memory page, the code for determining whether to enable address sanitization includes determines to enable address sanitization for the instruction for accessing memory.
